(19) United States
(12) Patent Application Publication
(10) Pub. No.: US 2015/0335001 A1
(43) Pub. Date: Nov. 26, 2015

(54) Electric Fishing Reel and Remote Operation System and Method

(71) Applicant: Miyamae Co., Ltd., Osaka (JP)

(72) Inventor: Toshiaki MIYAMAE, Osaka (JP)

(21) Appl. No.: 14/719,597

(22) Filed: May 22, 2015

(30) Foreign Application Priority Data
May 23, 2014 (JP) 2014-106853
Jan. 29, 2015 (JP) 2015-014998

(51) Int. Cl. A01K 89/017; A01K 99/00

(52) U.S. Cl. CPC A01K 89/017; A01K 99/00

(57) ABSTRACT

An electric fishing reel remotely operated by a mobile terminal in widespread use, such as a smartphone, may include a reel body, and a radio communication module complying with at least one of the Wi-Fi Standard or the Bluetooth specification in the reel body. The electric fishing reel may communicate with a mobile terminal having a radio communication module corresponding to the radio communication module of the electric fishing reel, and perform remote operation in response to an instruction signal transmitted from the mobile terminal during communication. A device identification code may be uniquely allocated to the reel body. A communication protocol connection may be established by causing the mobile terminal to read the device identification code before a remote operation. In embodiments, the mobile terminal may communicate with a plurality of remotely operated electric fishing reels.

### TECHNICAL FIELD

The present invention relates to a technique to remote operate an electric fishing reel that is driven by a motor to reel in a fishing line, and more in detail to a mechanism that remote operates the electric fishing reel in accordance with wireless fidelity (Wi-Fi) communication or Bluetooth® communication using a smartphone or a cellular phone as a remote terminal.

### BACKGROUND

Electric fishing reels with a reel controlled by a remote control are known. There are several known techniques that radio-link an electric fishing reel with a remote control. Such systems are disclosed, for example, in Japanese Unexamined Patent Application Publications Nos. 7-87864, 2001-161235, 2004-65071, and 2005-218354, the disclosures of which are incorporated herein by reference.

The advantages of wirelessly remote operation of an electric fishing reel are most apparent when a single fisherman goes fishing. In a professional fishing operation, that fisherman is supposed to do everything, including operating a reel, steering a fishing boat, and watching a fish finder. The use of a remote controllable reel allows that fisherman to focus on fishing while performing these other operations.

The advantages of a radio remote control operation are even more pronounced when multiple reels are used concurrently. The aforementioned Japanese Unexamined Patent Application Publication No. 2004-65071 discloses the technique in which a single remote control operates multiple reels.

The aforementioned Japanese Unexamined Patent Application Publication No. 2005-218354 discloses another technique, in which a remote control terminal displays a variety of information on a real-time basis, including an operational status of a reel and a warning to the fisherman alerting him to anything that could possibly reduce a fish catch. The fisherman may timely learn the operational status of the reel by watching an image displayed on the remote control terminal at hand. If any problem takes place, the fisherman may take appropriate action to control it.

With such devices, a remote control displays the status of a reel as necessary by remote controlling an electric fishing reel. In this case, a specialized remote control is used. Manufacturers of such electric fishing reels must invest capital to build a facility to manufacture the specialized remote control separate from the reel body. If the specialized remote controls are supplied together with the reel bodies, production yield increases, and costs per remote control are decreased. However, a person fishing as a hobby may not necessarily use a remote control. Generally, the specialized remote control is sold separately from the reel body.

The specialized remote control typically is different from reel type to reel type, and from manufacture to manufacturer. A user may be satisfied with the reel body, but may not be satisfied with user friendliness of the remote control. This limits the option of the user in the selection of reels.

A cellular phone or a smartphone, currently in widespread use as a mobile communication terminal, is provided with not only a basic communication function but also a Wi-Fi or Bluetooth® (a registered trademark of Bluetooth Sig, Inc. of Kirkland, Wash.) module. The cellar phone or the smartphone may thus radio-communicate with external devices, such as PC peripheral devices including a personal computer, and external devices including a headphone or a microphone. In particular, the smartphone or a tablet terminal, each having an OS and programs called “applications” or “apps” installed thereon, may perform a process in speed as high as a personal computer. Recently efforts have been made to develop a remote operation system in which even home appliances and automobiles are remote operated using a smartphone.

If a mobile communication terminal, such as a smartphone, not only being mobile but also having performance as high as a standard personal computer, is incorporated in a remote control of the electric fishing reel, the reel manufacture is free from capital investment for the facility producing the specialized remote control. The user also benefits from this because the user may use his or her already owned mobile terminal, such as a smartphone. The problems associated with the specialized remote control are all solved.

### SUMMARY

The present disclosure has been developed to address the aforementioned problems, and in embodiments provides an electric fishing reel that is remote controllable by a mobile terminal in widespread use, such as a smartphone.

The disclosed system includes an electric fishing reel having a reel body, and a radio communication module complying with at least one of the Wi-Fi specification and Bluetooth specification in the reel body. The reel body may communicate with a mobile terminal having a radio communication module corresponding to the radio communication module of the electric fishing reel. The reel body may receive an instruction signal (i.e., a command) transmitted from the mobile terminal, and in response to the received instruction signal, remote control functions of the electric fishing reel, including controlling a motor to reel in a fishing line, to stop reeling in the fishing line, to reel out the fishing line, to display data on an LCD (liquid-crystal display), to output audio, and to record a variety of data. A command used in the remote operation may be optionally set by the user.

In Wi-Fi or Bluetooth communications between the reel and the mobile terminal, a pairing operation between the two devices may need to be performed in advance (e.g., device registration to establish a communication protocol connection). To this end, a device identification code may be uniquely allocated to the reel body in advance of use, and the mobile terminal caused to read the device identification code to establish the communication protocol connection.

The device identification code may include a random numerical value, and may be manually input on the mobile terminal during the pairing operation. Alternatively, the device identification code may be recorded in a bar code attached to the reel body, and the mobile terminal may be caused to read the bar code. The mobile terminal then reads the bar code. The mobile terminal thus easily reads the device identification code without the need to manually enter the device identification code.

If the radio communication module is a Bluetooth module, in embodiments the device identification code is a PIN (personal identification number) code held by the Bluetooth module. The Bluetooth module may include a circuit board having a radio antenna and the like mounted thereon and may have a PIN code including any character string of 4 through 16 digits allocated on a per-module basis. By inputting the PIN code to a connection target device (for example, a mobile terminal) for reading, the communication protocol connection may be established in accordance with a profile such as GAP (generic access profile). The use of the PIN code as the device identification code of the electric fishing reel may eliminate the need to separately set up the device identification code, and the communication protocol connection is established with the mobile terminal through the generic access profile. The PIN code also may be referred to as a passkey, an authentication key, or a password.

The reel body may include a display, such as an LCD or an organic ELD (electroluminescent display), and transmit image information displayed on the display to the mobile terminal via the radio communication module. In this way, the user may check the status of the reel body by viewing the display of the mobile terminal at hand. The image information may be transmitted in whole or in part.

The electric fishing reel may transmit the notification signal via the radio communication module to the mobile terminal if the reel body is in an operational error state and/or at the end of an operation thereof. The mobile terminal may notify the user of the status of the reel body using image displaying, an audio output, and/or vibration motion on a real-time basis.

A remote operation system for an electric fishing reel may include the electric fishing reel described above, and a mobile terminal that includes a radio communication module communicable with the radio communication module disposed in the electric fishing reel, and a touchscreen, and has a specialized program installed therein and adapted to operate the electric fishing reel during communication with the electric fishing reel. The electric fishing reel may be remote operated in response to an operation performed on the touchscreen during an execution of the specialized program on the mobile terminal.

Each mobile terminal may correspond to an electric fishing reel on a one-to-one correspondence basis. Alternatively, however, the remote operation system may include electric fishing reels of N different device identification codes (where N is an integer equal to 2 or above), and the mobile terminal individually remotely operates the N electric fishing reels in accordance with the device identification codes.

More specifically, the radio communication module is a Bluetooth module, the device identification code of each of the N electric fishing reels is a PIN code held by the Bluetooth module disposed in the electric fishing reel. The mobile terminal establishes a communication protocol connection with each of the N electric fishing reels in accordance with the PIN code, newly allocates any device name to each of the N electric fishing reels independently of the PIN code, and remote controls each of the N electric fishing reels in accordance with the device name. If Bluetooth communication is performed with multiple devices having the same model name, the same model names are concurrently displayed on the mobile terminal. The user has difficulty in discriminating one from another. In accordance with the present invention, each of the N electric fishing reels having established the communication protocol connection in accordance with the PIN codes may have any device name the user, at their discretion, has assigned independently of the PIN code. Thus, the user easily may differentiate between each electric fishing reel currently in operation or to be operated. It is also possible to allocate and register the PIN code as a device name.

The mobile terminal may concurrently transmit the same instruction signal to the N electric fishing reels. The mobile terminal may be a smartphone. A communication module of Wi-Fi or Bluetooth may be included as standard. By simply installing the specialized program on the smartphone, the smartphone may be used as a remote control for the electric fishing reel. The smartphone is in widespread use and each user is typically used to operate the smartphone. The manufacturer of the electric fishing reel is not constrained to manufacture a specialized remote control.

According to the present disclosure, the reel body may include a radio communication module complying with at least one of the Wi-Fi specification and Bluetooth specification in the reel body, and the reel body communicates with the mobile terminal having the same radio communication module so that the mobile terminal remote operates the reel body. A specialized remote control in related art may be dispensed with. The use of a smartphone as a mobile terminal allows the user to use his or her own smartphone as a mobile terminal. The user is free from additional costs for the remote control. The user is used to operating his or her own smartphone. By simply installing the specialized program on the smartphone, the user may select a reel to be remotely operated from a wide range of reels in a manner free from a manufacturer's electric fishing reel specifications.

Other objects and advantages of the disclosed electric fishing reel and remote operation system will be apparent from the following description, the accompanying drawings, and the appended claims.

### BRIEF DESCRIPTION OF THE DRAWINGS

FIG. 1 is a schematic diagram generally illustrating an embodiment of the disclosed remote operation system for an electric fishing reel;

FIG. 2 is a flowchart illustrating a process of a remote operation of the remote operation system;

FIG. 3 is a startup screen of an application of the disclosed remote operation system displayed on a smartphone; and

FIG. 4 is a schematic diagram showing an example of a notification from the disclosed remote operation system displayed on the smartphone of FIG. 3.

### DETAILED DESCRIPTION

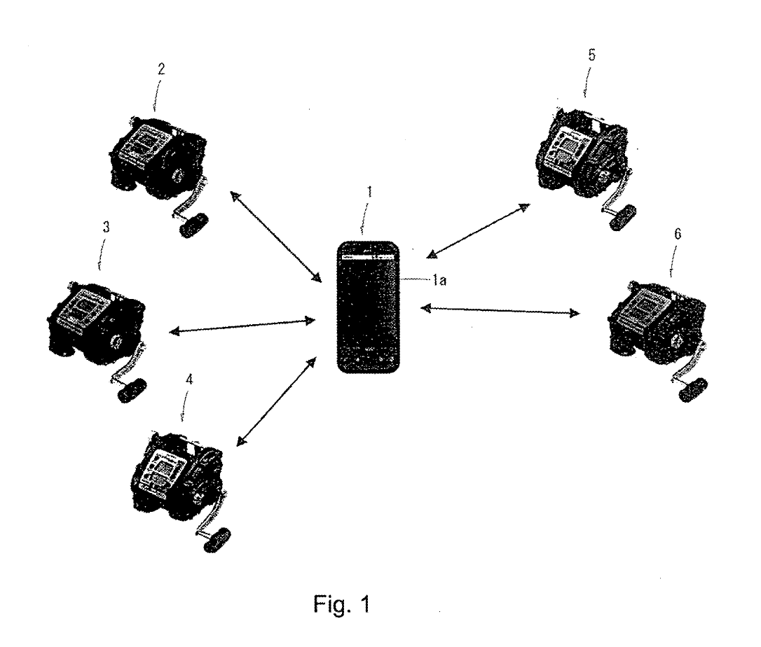

As shown in FIG. 1, the disclosed electric fishing reel and remote operation system may employ a smartphone 1 and a plurality of electric fishing reels 2, 3, 4, 5, and 6. The smartphone 1 may include a touchscreen 1a serving as an input device and a display device. The smartphone 1 also may include an internal CPU and memory (neither of which is shown), and a radio communication module that complies with Wi-Fi and/or Bluetooth standards. The OS may be pre-installed in memory on the smartphone 1, and individual programs (also referred to “applications” or “apps”) supported by the OS may be installed on the smartphone.

The disclosed system may include a specialized program that operates the electric fishing reels 2-6 loaded on the smartphone 1. The contents of the specialized program may be identical to a motor control program of each of the electric fishing reels 2-6. More specifically, each of the electric fishing reels 2-6 may include a CPU and memory, and execute a motor control program on the reel. By executing the motor control program, each of the electric fishing reels 2-6 may set a shelf location, reel in a fishing line in response to a fish biting (i.e., a load), and display these pieces of information. Such control of the fishing reels 2-6 may be possible by directly operating a variety of switches disposed in the reel body. In accordance with the disclosed system, however, the user may perform the same control of the fishing reels 2-6, that is to say, all of the same functions as the motor control program of the reel, by way of the specialized program loaded on the smartphone 1.

Each of the electric fishing reels 2-6 may include one or both of Wi-Fi and Bluetooth modules (not shown) as a specific unit to remote operate the electric fishing reels 2-6 with the smartphone 1. The smartphone 1 radio-communicates with the electric fishing reels 2-6 in accordance with the Wi-Fi and/or Bluetooth connection. The user may elect at their discretion whether to use the Wi-Fi or Bluetooth connection. The Wi-Fi connection may be appropriate for high-capacity communication, but an access point may be needed to connect the smartphone 1 to the Internet, and communication costs incur. On the other hand, the Bluetooth connection may not be appropriate for high-capacity communication, but does not need an access point and offers an advantage of permitting direct pairing with a partner device. Furthermore, the Bluetooth connection may outperform an infrared data connection in that the Bluetooth connection is usable if an interfering object is present within a communication coverage of 10 meters. The Bluetooth connection may consume less power than the infrared data connection, and involve lower manufacturing costs than an infrared data connection.

The radio communication may be based on the premise that each of the electric fishing reels 2-6 may be tagged with a unique device identification code. The communication protocol connection with the electric fishing reels 2-6 may be established by causing the smartphone 1 to read the device identification code. When the smartphone 1 transmits an instruction signal, the smartphone 1 also may broadcast the device identification code, and is thus enabled to remotely operate the one of the electric fishing reels 2-6 tagged with that code. Conversely, when information is transmitted from the electric fishing reels 2-6 to the smartphone 1, the device identification also may transmit a signal to cause the smartphone 1 to recognize which of the electric fishing reels 2-6 the information is received from. In accordance with the embodiment, the five electric fishing reels, namely, the electric fishing reels 2-6 may be used. If the number of electric fishing reels is one, two, three, four, five, six, or more, the pairing operation performed using the device identification code may remain unchanged.

In order to cause the smartphone 1 to read the device identification code, the device identification code may be written in numerical value on a product label. In such a case, the numerical value may be directly input to the smartphone 1 manually by a user. However, time is needed to input the numerical value and an input error may occur. There is also a possibility that a third person may use the code in an unauthorized fashion. The device identification code may be converted into a bar code (not shown) attached to the reel body, for example. If the smartphone 1 has a camera function, a photograph may be taken of the bar code, and from that the specialized program on the smartphone may analyze the device identification code embodied in the bar code with a bar code application or module.

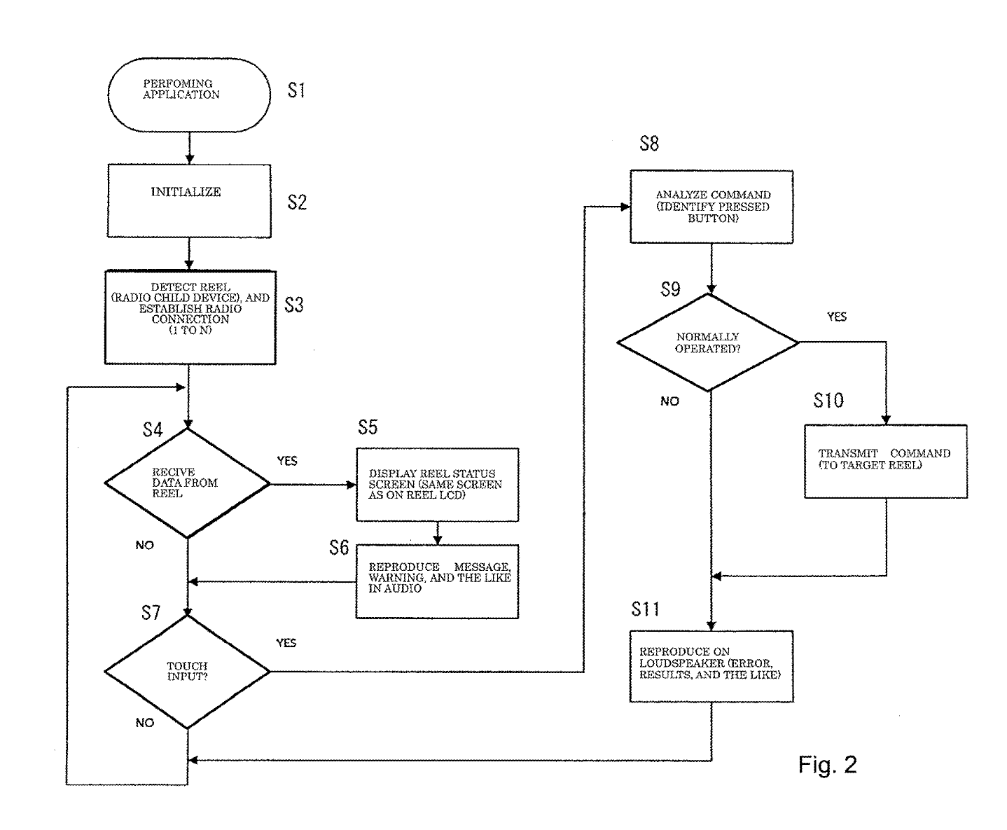

FIG. 2 shows a flowchart of one embodiment of a process for remote operation of the disclosed remote operation system by the specialized program application loaded in the smartphone 1. In step S1, the user may switch on the smartphone 1 and start up the specialized program application for remote operation of one or more of the electric fishing reels 2-6 (FIG. 1) from among applications installed on the smartphone. In step S2, the smartphone 1 may initialize the specialized application. In step S2, the specialized application may display a screen requesting the device identification code to be input to perform the pairing operation with one or more of the electric fishing reels 2-6. In step S3, the communication protocol connection between the smartphone 1 and the electric fishing reels 2-6 may be established in accordance with the input device identification codes of the electric fishing reels. Once the communication protocol connection is established, that status may be saved and thus steps S2 and S3 may be skipped in future processes.

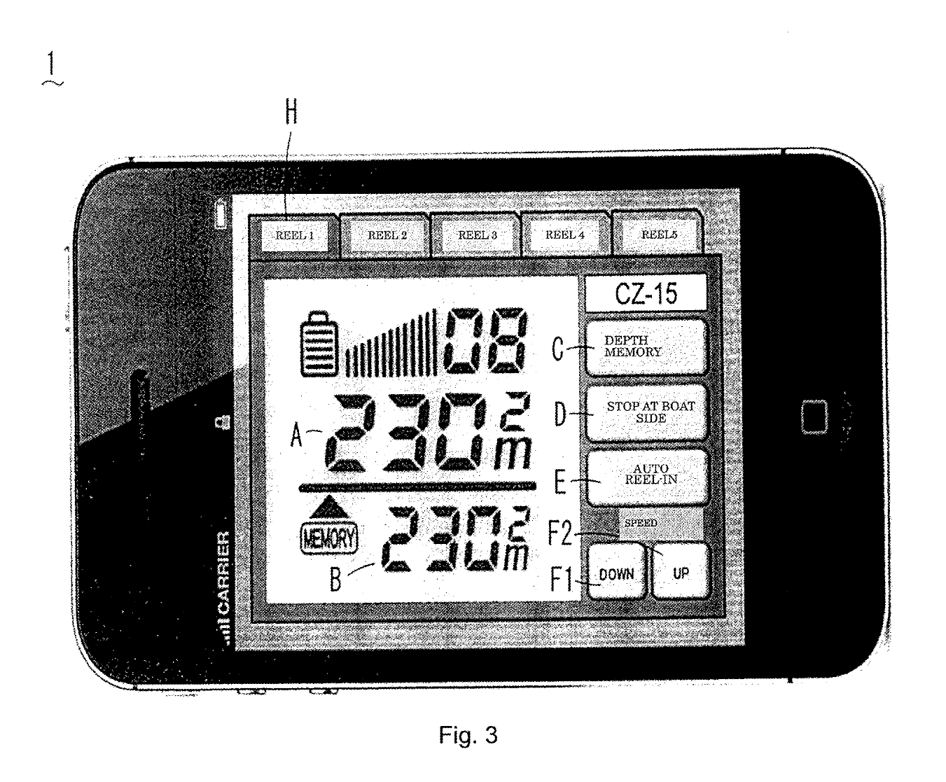

The communication protocol connection may be established in this way. In preparation for the remote operation, the specialized program running in the smartphone 1 may determine whether information indicating the status of each of the electric fishing reels 2-6 has been received (step S4). This information may be the same image information received from one or more of the electric fishing reels 2-6 and displayed on a display (see FIG. 3), if the electric fishing reels include an LCD or an organic ELD. The image information may be displayed on the touchscreen 1a of the smartphone 1 (step S5). In addition to displaying the image information, information about the status of one or more of the reels 2-6 and the presence or absence of any fault may be indicated by a message, audio, or vibration motion (step S6).

If it is determined in step S4 that no data has been received from one or more of the reel or reels 2-6, or subsequent to steps S5 and S6, the specialized application on the smartphone 1 may determine whether an input (operation) has been entered on the touchscreen 1a in the smartphone (step S7) in order to perform remote operation on one or more of the electric fishing reels 2-6. If it is determined that no input has been entered, processing may return to step S4. If it is determined that an input has been entered, a command as the input may be analyzed (step S8). It then may be determined whether the input (operation) is normal (step S9). If the input is a normal command, the instruction signal is transmitted to one or more of the reels 2-6 (step S10). By transmitting the device identification code, the command may be transmitted to the reel having the command allocated thereto. The same command may be transmitted to all the reels 2-6 that have established the communication protocol connection (broadcast function).

Each of the electric fishing reels 2-6 having received the instruction signal in step S10 may start an operation responsive to the received command. For example, the fishing line is cast and the distal end of the fishing line reaches a shelf or the bottom of the sea or other body of water being fished. A spool in one or more of the electric fishing reels 2-6 then may be shifted from a free rotation state to a clutched state ready to reel in the fishing line. To reel in the fishing line, the motor of the reel may start, and then stop at an appropriate timing. To adjust reel-in speed, the motor speed may be adjusted to a set speed during the reel-in operation.

FIG. 3 is an example of a display on the touchscreen 1a of the remote operation specialized application as it is starting up on the smartphone 1. In this display example, a check screen to display the reel status may include a depth screen A indicating a reel-out length of the fishing line from the reel. A shelf depth B may be displayed below the depth screen A. A display screen of commands to generate instruction signals to the reel may be displayed to the right of the check screen and include a depth memory C selectable by tapping, a stop at boat side D, an auto reel-in E, and speed settings F1 and F2. An antenna screen G as an indicator of the communication state with the reel is disposed above the depth screen A. The display screen is prepared for each of the electric fishing reels 2-6, and by tapping a tag H at the top of the display screen, the display screen is switched for one of the reels 2-6 to another.

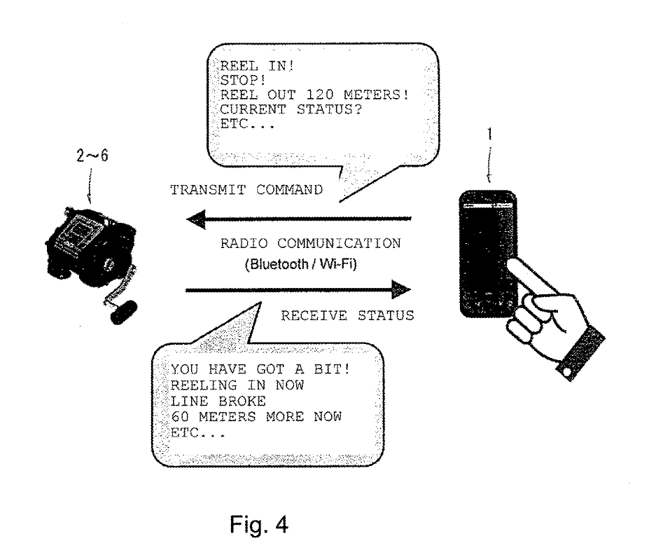

If an operation result is obtained in the remote operation in step S10 or a fault is detected during the operation of each of the electric fishing reels 2-6, a notification signal (status) may be received from each of the electric fishing reels 2-6. The smartphone 1 thus may alert the user to the fault using the image display, the audio, or the vibration motion (step S11). FIG. 4 illustrates a notification example using the audio or message.

Processing returns to step S4 to repeat the steps until the application is terminated.

In the configuration and process of the disclosed embodiments of the electric fishing reel and remote operation system, the configuration and process is described in connection with the smartphone 1. In other embodiments the smartphone 1 may take the form of a cellular phone (old-fashioned cell phone), a tablet, an iPad®, a laptop, or other portable and/or mobile personal digital assistant (PDA), all of which, including the smartphone, may be collectively referred to as a remote terminal. In embodiments, the mobile terminal may be at least one of a Wi-Fi module and Bluetooth module. The number of reels to be remotely operated is not limited to five. In embodiments, the number of reels 2-6 controlled by the specialized program in the smartphone 1 may be one, two, three, four, six or more. In the embodiment, the electric fishing reels 2-6 may include at least one of a Wi-Fi module or Bluetooth radio communication module, have a unique device identification code, and establish the required communication protocol connection with the mobile terminal.

The mobile terminal may be desirably provided with a touchscreen, but may be of a type in which a display and an input device (e.g., a keyboard) are separated from each other. In the embodiment, the mobile terminal may generate an instruction signal in response to an input command, transmit the instruction signal to one or more of the electric fishing reels 2-6, and cause one or more of the electric fishing reels to execute the instruction signal. The mobile terminal may receive status information from one or more of the electric fishing reels 2-6, display the status information on the display, and alert the user using the audio and/or the vibration motion. With the remote control program installed, the mobile terminal remotely operates the electric fishing reels 2-6 more effectively and easily, but the contents of the program are not limited.

If the Bluetooth module is used as a radio communication module, the PIN code of each module may be used conveniently as the device identification code of the reels 2-6. After establishing the communication protocol connection (S3 in FIG. 2), any device name is newly attached to each reel separate from the PIN code or a model name. The user (mobile terminal) may easily identify which reel is going to be operated or is now operated by the device name. The device name may be displayed in the “reel 1 through reel 5” at the tag H in FIG. 3. In the case of boat fishing, the device names may be “port 1 through port 3” and “starboard 2 through 3” depending on the locations of the reels 2-6 on the boat.

### REFERENCE NUMBERS LIST

1 Smartphone
1a Touchscreen
2-6 Electric fishing reels

What is claimed is:

1. A electric fishing reel comprising:
a reel body; and
a first radio communication module in the reel body, the radio communication complying with at least one of the Wi-Fi specification and Bluetooth specification, wherein the radio communication module in the reel body communicates with a mobile terminal having a second radio communication module corresponding to the first radio communication module of the electric fishing reel, and performs remote operation in response to an instruction signal transmitted from the mobile terminal during communication.

2. The electric fishing reel according to claim 1, wherein a device identification code is uniquely allocated to the first radio communication module in the reel body, and the mobile terminal reads the device identification code to establish a communication protocol connection with the first radio communication module.

3. The electric fishing reel according to claim 2, wherein the device identification code is recorded in bar code attached to the reel body.

4. The electric fishing reel according to claim 2, wherein the first radio communication module is a Bluetooth module, and the device identification code is a PIN code held by the Bluetooth module.

5. The electric fishing reel according to claim 1, wherein the reel body comprises a display, and transmits image information displayed on the display to the second communication module of the mobile terminal via the first radio communication module.

6. The electric fishing reel according to claim 1, wherein the electric fishing reel transmits the notification signal via the first radio communication module to the mobile terminal if the reel body is in an operational error and/or at an end of an operation.

7. A remote operation system for an electric fishing reel, the system comprising:
the electric fishing reel according to claim 1; and
a mobile terminal that includes a second radio communication module communicable with the first radio communication module disposed in the electric fishing reel, a touchscreen, and a specialized program installed therein that operates the electric fishing reel during communication with the electric fishing reel, wherein the electric fishing reel is remotely operated in response to an operation performed on the touchscreen during an execution of the specialized program on the mobile terminal.

8. The remote operation system for the electric fishing reel according to claim 7, further comprising a plurality of the electric fishing reels of N unique device identification codes, where N is an integer greater than or equal to 2; and wherein the mobile terminal individually remotely operates the N electric fishing reels in accordance with the device identification codes.

9. The remote operation system for the electric fishing reel according to claim 8, wherein the specialized program causes the mobile terminal to transmit an instruction signal with a selected one of the device identification codes to remotely operate one of the plurality of the electric fishing reels tagged with the selected one of the device identification codes.

10. The remote operation system for the electric fishing reel according to claim 9, wherein one of the plurality of the electric fishing reels is programmed to transmit information with an associated one of the unique device identification codes the specialized program; and the specialized program causes the mobile terminal to read the information with the associated one of the unique device identification codes and recognize which of the plurality of electric fishing reels the information is received from.

11. The remote operation system for the electric fishing reel according to claim 8, wherein the radio communication module is a Bluetooth module, the device identification code of each of the N electric fishing reels is a PIN code held by the Bluetooth module disposed in the electric fishing reel, the mobile terminal establishes a communication protocol connection with each of the N electric fishing reels in accordance with the PIN code, newly allocates any device name to each of the N electric fishing reels independently of the PIN code, and remote controls each of the N electric fishing reels in accordance with the device name.

12. The remote operation system for the electric fishing reel according to claim 8, wherein the mobile terminal concurrently transmits the same instruction signal to the N electric fishing reels.

13. A remote operation system for the electric fishing reel according to claim 7, wherein the mobile terminal is selected from a smartphone, a tablet, a laptop, a cellular phone, and an iPad.

14. A method for making a remote operation system for an electric fishing reel, the method comprising:
providing a reel body of an electric fishing reel with a first radio communication module;
providing a specialized program to be run on a mobile terminal, the mobile terminal having a second communication module communicable with the first radio communication module; and
configuring the specialized program to perform a remote operation by the reel body in response to an instruction signal inputted by a user and transmitted from the mobile terminal during communication between the mobile terminal and the reel body.

15. The method according to claim 14, further comprising configuring the specialized program to receive and display on the mobile terminal one or more of a status of the electric fishing reel and the communication state with the electric fishing reel.

16. The method according to claim 15, wherein configuring the specialized program to receive and display on the mobile terminal a status of the electric fishing reel includes receiving and displaying information pertaining to reel-out length of the fishing line from the reel, and a shelf depth.

17. The method according to claim 14, wherein configuring the specialized program to perform a remote operation by the reel body in response to an instruction signal inputted by a user includes configuring the specialized program to generate an instruction signal to the electric fishing reel to set a shelf location, reel in a fishing line in response to a fish biting, and display these pieces of information on the mobile terminal.

18. The method according to claim 14, further comprising configuring the specialized program to perform a remote operation on a plurality of the electric fishing reels; providing each of the plurality of the electric fishing reels with a unique device identification code; and configuring the specialized program to cause the mobile terminal to broadcast the unique device identification code to remotely operate a one of the plurality of electric fishing reels tagged with the unique device identification code.

19. The method according to claim 18, further comprising configuring the specialized program to recognize which of the plurality of the electronic fishing reels is transmitting information.

20. The method according to claim 19, wherein configuring the specialized program includes configuring the specialized program to determine whether information indicating the status of each of the plurality of the electric fishing reels has been received.
